(19) United States
(12) Patent Application Publication
(10) Pub. No.: US 2007/0153108 A1
(43) Pub. Date: Jul. 5, 2007

(54) SOLID-STATE IMAGE SENSOR

(76) Inventor: Hisanori IHARA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/619,375

(22) Filed: Jan. 3, 2007

(30) Foreign Application Priority Data
Jan. 5, 2006 (JP) 2006-000749

(51) Int. Cl. H04N 5/335; H04N 3/14

(52) U.S. Cl. 348/300

(57) ABSTRACT

There is disclosed a solid-state image sensor having an image region including a plurality of unit cells arrayed in a matrix on a semiconductor substrate, in which each of the unit cells includes a photodiode provided in the semiconductor substrate, which converts an input light signal into a signal charge and stores the signal charge, a MOS type read transistor provided adjacent to the photodiode in a surface layer of the semiconductor substrate, which transfers the signal charge stored in the photodiode to a signal charge detecting portion, and an amplifying transistor which amplifies the signal charge transferred to the signal charge detecting portion to output a voltage signal, wherein the signal charge detecting portion comprises an ion implantation region formed in a part of a surface layer of a semiconductor region on a drain side of the MOS type read transistor.

### CROSS-REFERENCE TO RELATED APPLICATIONS

This application is based upon and claims the benefit of priority from prior Japanese Patent Application No. 2006-000749, filed Jan. 5, 2006, the entire contents of which are incorporated herein by reference.

### BACKGROUND OF THE INVENTION

1. Field of the Invention

The present invention relates to a solid-state image sensor, and in particular, to a cell pattern in an amplification type CMOS image sensor used for, for example, portable electronic apparatuses.

2. Description of the Related Art

Conventionally, an amplification type CMOS image sensor having an amplifying function in a pixel section has been expected as a sensor suitable for an increase of the number of pixels and for reduction of a pixel size corresponding to the image size reduction. Moreover, the amplification type CMOS image sensor has low power consumption as compared with a charge coupled device (CCD) sensor. In addition, it is easy to integrate with other peripheral circuits manufactured via the same CMOS process as the CMOS process for manufacturing a sensor part. Therefore, the amplification type CMOS image sensor has much interest.

For example, a unit cell of a solid-state image sensor is formed of a photodiode, a MOS type read transistor, a MOS type amplifying transistor, a MOS type vertical select transistor, and a MOS type reset transistor. The MOS type read transistor transfers a signal charge stored in the photodiode to a signal charge detecting portion. The MOS type amplifying transistor amplifies the signal charge transferred to the signal charge detecting portion to output a voltage signal. The MOS type vertical select transistor transfers the output voltage signal of the MOS type amplifying transistor (i.e., an amplified output of the MOS type amplifying transistor) to a vertical output line. The MOS type reset transistor resets the signal charge detected by the signal charge detecting portion.

The signal charge detecting portion of the conventional unit cell is formed of an ion implantation region formed by implanting impurity ions, for example, N-type impurity ions, into the entire surface of a semiconductor region on the side of a drain of the read transistor. Conversion gain of the read transistor is determined by an area of the ion implantation region. In the conventional unit cell, the ion implantation region is formed on the entire surface of a semiconductor region on the side of a drain of the read transistor, and thus, the area of the ion implantation region is large. For this reason, the conversion gain of the read transistor is small. As a result, it is difficult to make the saturation voltage of the signal charge detecting portion high, with the result that it is difficult to make a saturation output of the sensor high, and the signal-to-noise ratio is degraded.

Jpn. Pat. Appln. KOKAI Publication No. 2005-101442 discloses a solid-state image sensor in which ion implantation is carried out twice to form a high impurity concentration region.

### BRIEF SUMMARY OF THE INVENTION

According to an aspect of the present invention, there is provided a solid-state image sensor having an image region including a plurality of unit cells arrayed in a matrix on a semiconductor substrate, in which each of the unit cells comprises:

a photodiode provided in the semiconductor substrate, which converts an input light signal into a signal charge and stores the signal charge;

a MOS type read transistor provided adjacent to the photodiode in a surface layer of the semiconductor substrate, which transfers the signal charge stored in the photodiode to a signal charge detecting portion; and

an amplifying transistor which amplifies the signal charge transferred to the signal charge detecting portion to output a voltage signal,

wherein the signal charge detecting portion comprises an ion implantation region formed in a part of a surface layer of a semiconductor region on a drain side of the MOS type read transistor.

### BRIEF DESCRIPTION OF THE SEVERAL VIEWS OF THE DRAWING

FIG. 1 is a detailed circuit diagram showing an amplification type CMOS image sensor according to a first embodiment of the present invention, in particular, one unit cell of the amplification type CMOS image sensor;

FIG. 2 is a top plan view of the unit cell shown in FIG. 1, showing a pattern of the unit cell;

FIG. 3 is a cross-sectional view of the unit cell of FIG. 2, taken along a line III-III in FIG. 2;

FIG. 4 is a cross-sectional view of the amplification type CMOS image sensor according to the first embodiment of the present invention, in a manufacturing process;

FIG. 5 is a cross-sectional view of the amplification type CMOS image sensor according to the first embodiment of the present invention, in a manufacturing process following the manufacturing process shown in FIG. 4;

FIG. 6 is a characteristic chart showing the relationship between an area of signal charge detecting portion of the unit cell and saturation output voltage of the sensor of the first embodiment, using a saturation voltage of a conventional CMOS image sensor as a reference value;

FIG. 7 is a top plan view showing a pattern of a two-pixel one-cell type unit cell in an amplification type CMOS image sensor according to a second embodiment of the present invention;

FIG. 8 is a top plan view showing a pattern of a four-pixel one-cell type unit cell in an amplification type CMOS image sensor according to a third embodiment of the present invention;

FIG. 9 is an enlarged cross-sectional view of a portion of the unit cell shown in FIG. 3; and

FIG. 10 is a cross-sectional view showing another structure of the unit cell shown in FIG. 3.

### DETAILED DESCRIPTION OF THE INVENTION

Embodiments of the present invention will be hereinafter described with reference to the accompanying drawings. In the following description, the same reference numbers are used to designate parts in common to all drawings.

A solid-state image sensor according to the embodiments of the present invention has, as a basic configuration, an image pick-up region and a signal scanning region. The image pick-up region is formed of unit cells arrayed in a matrix on a semiconductor substrate. The signal scanning region scans the image pick-up region to read a signal from each unit cell.

### First Embodiment

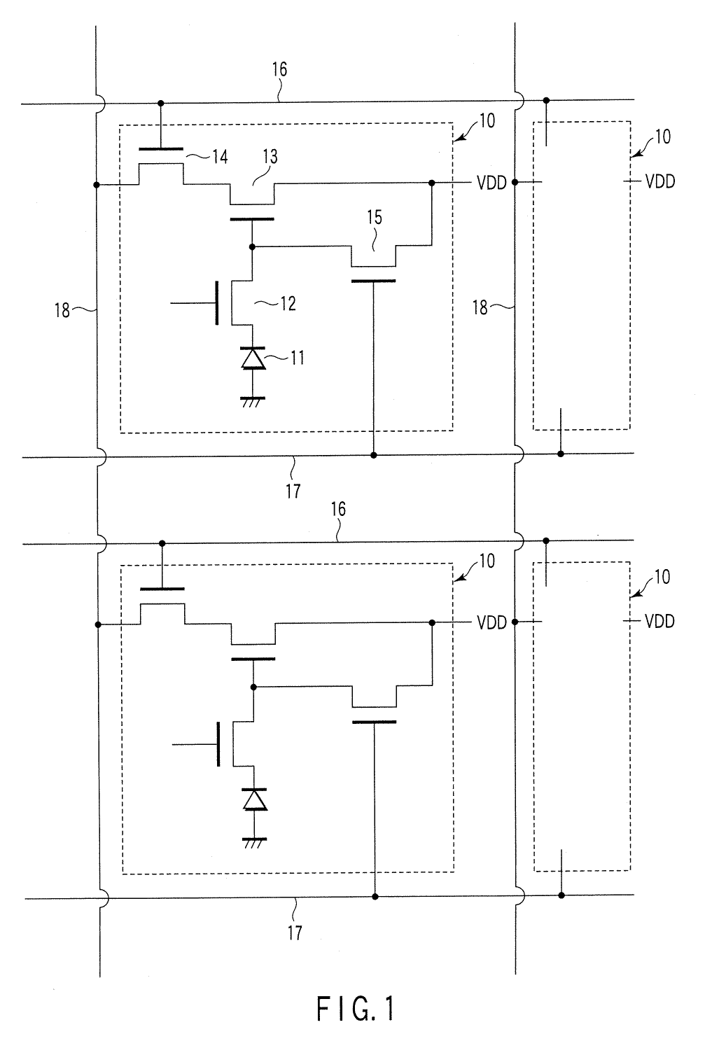

FIG. 1 is a detailed circuit diagram showing an amplification type CMOS image sensor according to a first embodiment of the present invention, in particular, one unit cell 10 of the amplification type CMOS image sensor.

A unit cell 10 is formed of a photodiode 11, a MOS type read transistor 12, a MOS type amplifying transistor 13, a MOS type vertical select transistor (address transistor) 14, a MOS type reset transistor 15, an address gate interconnection 16, and a reset gate interconnection 17. The MOS type read transistor 12 transfers a storage signal stored in the photodiode 11 to a signal charge detecting portion. The amplifying transistor 13 amplifies the signal charge transferred to the signal charge detecting portion to output a voltage signal. The MOS type vertical select transistor 14 transfers the output voltage signal of the amplifying transistor 13 (i.e., an amplified output of the amplifying transistor 13) to a vertical output line 18. The MOS type reset transistor 15 resets the signal charge detected by the signal charge detecting portion.

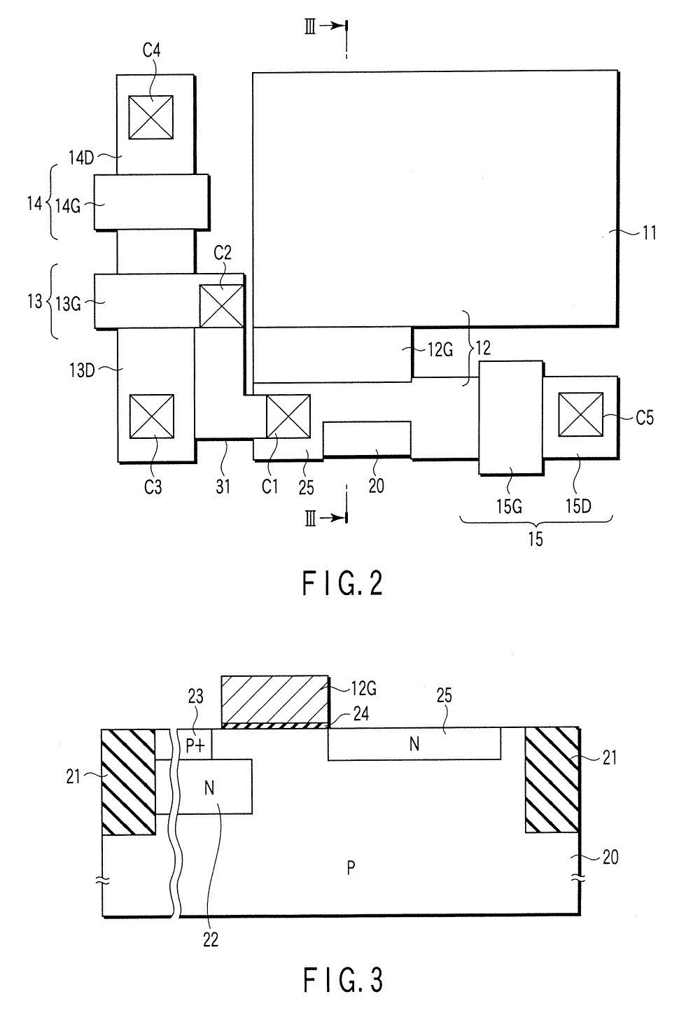

FIG. 2 is a top plan view of the unit cell shown in FIG. 1, showing a pattern of the unit cell. FIG. 3 is a cross-sectional view of the unit cell of FIG. 2, taken along a line III-III in FIG. 2.

As seen from FIG. 2 and FIG. 3, a surface layer of a P-well 20 formed on a surface of a semiconductor substrate is formed with a shallow trench isolation (STI) region 21. An element region surrounded by the STI 21 is formed with the unit cell 10 having the configuration shown in FIG. 1.

The P-well 20 of the unit cell 10 is provided with the photodiode 11 at a predetermined position in the plane. The photodiode 11 photo-electrically converts an input light signal, stores a signal charge obtained from photo-electrical conversion. The photodiode 11 comprises an N-type impurity diffusion region 22 and a surface shield layer 23. The N-type impurity diffusion region 22 is formed at the position separating from the surface of the P-well 20 by a predetermined distance in the depth direction. The surface shield layer 23 comprises a high concentration P+ diffusion layer formed at the surface layer of the P-well 20.

The surface layer of the P-well 20 is further formed with the MOS type read transistor 12 for transferring a storage signal stored in the photodiode to a signal charge detecting portion, near the photodiode 11. In FIG. 3, reference number 12G indicates a read gate electrode, which is formed on a channel region (part of the surface layer of P-well) of the read transistor 12 via a gate insulating film 24.

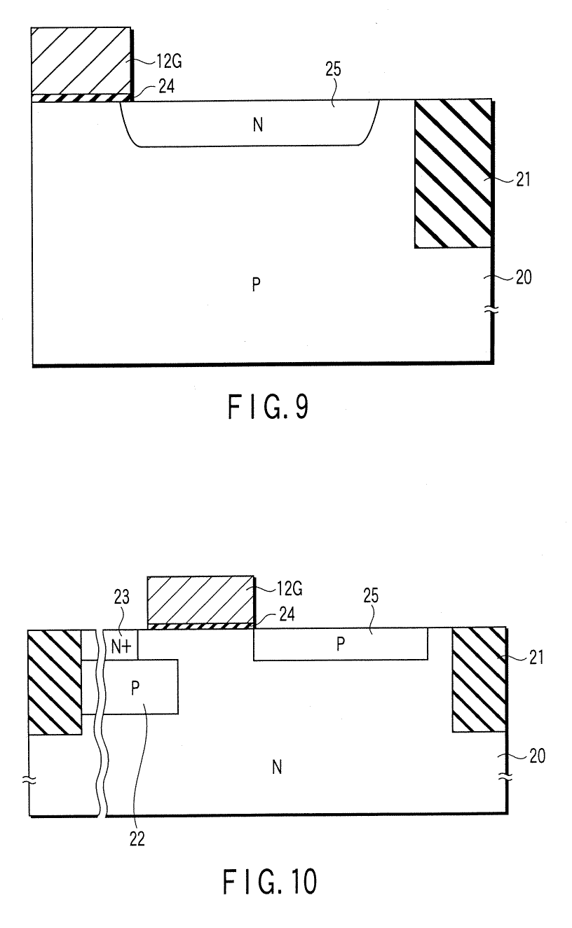

According to this embodiment, an ion implantation region (N-type impurity region) 25 is formed as a signal charge detecting portion. The ion implantation region 25 is formed in a manner of implanting N-type impurity ions (e.g., phosphorus ions P) in a part of a semiconductor region on the drain side of the read transistor 12. Since the impurity ions (e.g., phosphorus ions P) implanted in the part of the semiconductor region on the drain side of the read transistor 12 are diffused into the semiconductor region not only in the depth direction but also in the lateral direction, the ion implantation region 25 thus actually formed at the surface layer of the semiconductor region extends over the side edge of the gate electrode 12G of the read transistor 12, as shown in FIG. 9. In other words, the ion implantation region 25 includes an impurity diffused semiconductor portion under the side edge of the gate electrode 12G of the read transistor 12.

The width of the ion implantation region 25 in the channel direction of the read transistor 12 is smaller than the width of the semiconductor region on the drain side of the reset transistor 15. The width of the semiconductor region on the drain side of the reset transistor 15 is a width in a direction perpendicular to the channel direction of the reset transistor 15.

Moreover, a MOS type amplifying transistor 13 is formed in the vicinity of the read transistor 12. In FIG. 2, reference number 13G is a gate electrode (amplifying gate electrode) of the amplifying transistor 13. Reference number 31 is an amplifying gate electrode interconnection connecting the ion implantation region 25 with the amplifying gate electrode 13G. The amplifying gate electrode interconnection 31 is connected with the ion implantation region 25 via a contact C1 while being connected with the amplifier gate electrode 13G via a contact 2C. A drain region 13D of the amplifying transistor 13 is supplied with a power supply voltage VDD via a contact 3C, and the amplifying transistor 13 amplifies a signal charge of the ion implantation region to output a voltage signal.

A MOS type vertical select transistor 14 is formed adjacent to the amplifying transistor 13. In FIG. 2, reference number 14G is a gate electrode (address gate electrode) of the vertical select transistor 14. A drain region 14D of the vertical select transistor 14 is connected with a vertical output line 18 via a contact C4. In this way, the vertical select transistor 14 transfers a voltage signal (i.e., an amplified output) of the amplifying transistor 13 to the vertical output line 18.

A MOS type reset transistor 15 is formed adjacent to the ion implantation region 25. In FIG. 2, reference number 15G is a gate electrode (reset gate electrode) of the reset transistor 15. A drain region 15D of the reset transistor 15 is supplied with a reset voltage via contact C5, and the reset transistor 15 resets the charge of the ion implantation region 25.

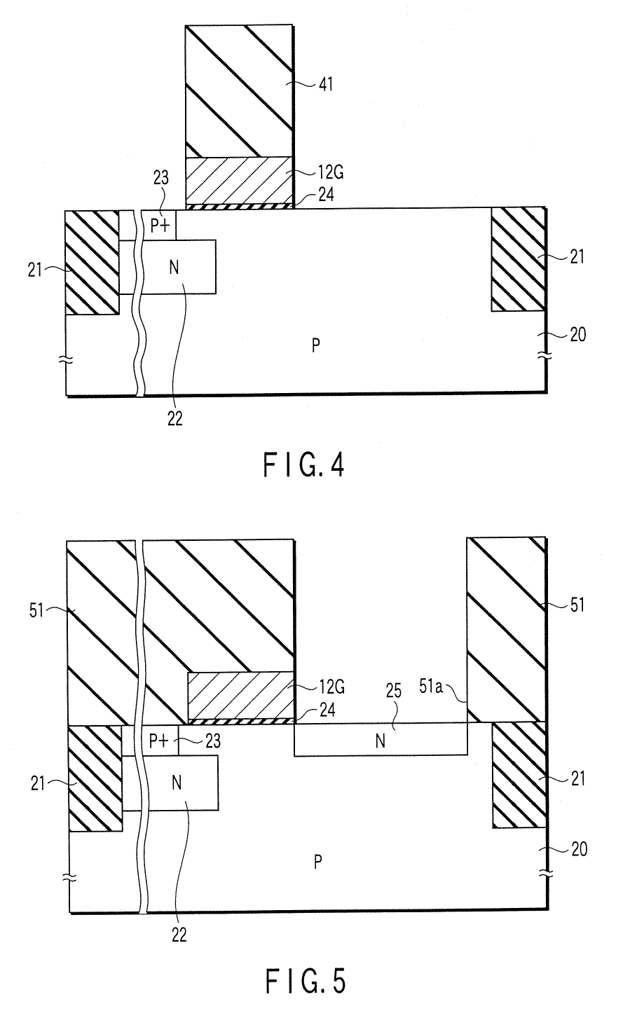

The process of manufacturing the CMOS image sensor of this embodiment will be described with reference to cross-sectional views shown in FIG. 4 and FIG. 5. As shown in FIG. 4, the surface layer of the semiconductor substrate is formed with a P-well 20. The surface layer of the P-well 20 is formed with STI 21. A unit cell is formed at a semiconductor region surrounded by STI 21, that is, element formation region in the following manner.

First, a gate insulating film 24 and a polysilicon layer are deposited on the entire surface of the semiconductor substrate. Thereafter, a resist pattern 41 is formed at a predetermined portion on the polysilicon layer. Etching is carried out using the resist pattern 41 as a mask, and thereby, the polysilicon layer and the gate insulating film 24 are patterned. In the manner described above, gates of several MOS type transistors are formed. FIG. 4 and FIG. 5 show the cross section of the read transistor 12 only. Reference number 12G denotes a read gate electrode formed of the polysilicon layer of the read transistor 12. Thereafter, the resist pattern 41 is removed.

As illustrated in FIG. 5, a resist pattern 51 is formed on the patterned polysilicon layer and semiconductor substrate at a predetermined portion. The resist pattern 51 on the semiconductor region on the drain side of the read transistor 12 extends from the upper surface of STI 21 onto the P well 20 to cover part of the semiconductor region on the drain side of the read transistor 12. In FIG. 5, reference number 51a denotes the end of the resist pattern 51 extending onto the P well 20.

Thereafter, N type impurity ions, for example, P (phosphorus) ions are implanted using the resist pattern 51 as a mask. The ion implantation region is determined by the resist pattern 51. By the ion implantation, the ion implantation region 25 is formed in a part of the semiconductor region on the drain side of the read transistor 12. More specifically, the region 25 is formed in the part of the semiconductor region, ranging from the position determined by self-align by the read gate electrode 12G of the read transistor 12 to the position determined by the end 51a of the resist pattern 51. Since the impurity ions (e.g., phosphorus ions) implanted in the part of the semiconductor region on the drain side of the read transistor 12 are diffused into the semiconductor region not only in the depth direction but also in the lateral direction, the ion implantation region 25 thus actually formed at the surface layer of the semiconductor region extends over the side edge of the gate electrode 12G of the read transistor 12, as shown in FIG. 9. In other words, the ion implantation region 25 includes an impurity diffused semiconductor portion under the side edge of the gate electrode 12G of the read transistor 12.

The width of the ion implantation region 25 in the channel direction of the read transistor 12 is smaller than the width of the semiconductor region on the drain side of the reset transistor 15. The width of the semiconductor region on the drain side of the reset transistor 15 is a width in a direction perpendicular to the channel direction of the reset transistor 15.

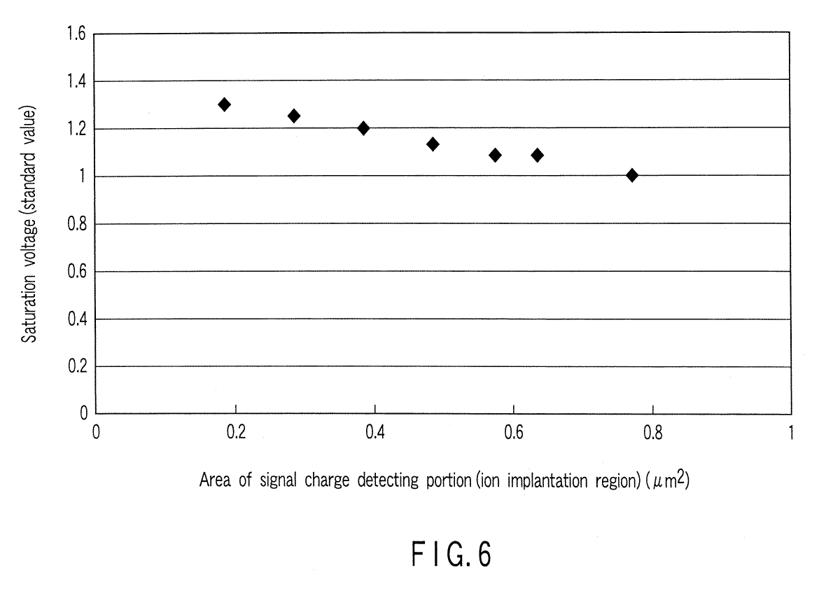

FIG. 6 is a characteristic chart showing the relationship between an area of the ion implantation region 25 of the unit cell 10 and a saturation output voltage of the sensor of the first embodiment, using a saturation voltage of a conventional CMOS image sensor as a reference value. As seen from FIG. 6, even if the area of the ion implantation region is made small, that is, about 0.2 μm², according to this embodiment, the saturation voltage increases 1.3 times as much as a conventional example. Therefore, a CMOS image sensor having a high signal-to-noise ratio is realizable according to this embodiment.

As described above, with the CMOS image sensor according to the first embodiment of the present invention, the ion implantation region 25 functioning as the signal charge detecting portion is formed in a part of the semiconductor region on the drain side of the read transistors 12. Therefore, the conversion gain of the read transistor of the unit cell having the amplifier function is increased, with the result that the saturation output is made high, and as a result, the signal-to-noise ratio of the output is improved.

The CMOS image sensor of the first embodiment further has the following features. The signal charge detecting portion is constituted by the ion implantation region 25, which is a part of the drain side region of the read transistor. Therefore, the conversion gain of the read transistor is readily controlled, and this is excellent in productivity. For example, the pattern of the drain side region of the read transistor is set fixed, while the pattern of the ion implantation region 25 is changed, so that the conversion gain of the read transistor can be changed, thereby changing the saturation voltage characteristics. Therefore, a CMOS image sensor having different saturation voltage characteristics is readily realized.

According to the first embodiment, a one-pixel one-cell type configuration having one pixel per one cell is given as the unit cell. The present invention is not limited to this type of configuration. For example, the present invention is applicable to the other types of unit cells, that is, to two-pixel one-cell type having two pixels per one cell or four-pixel one-cell type having four pixels per one cell. In other words, the present invention is applicable to a solid-state image sensor, in which several pairs of signal storage regions and read transistors are arranged in one unit cell, and the read transistors have a common ion implantation region.

### Second Embodiment

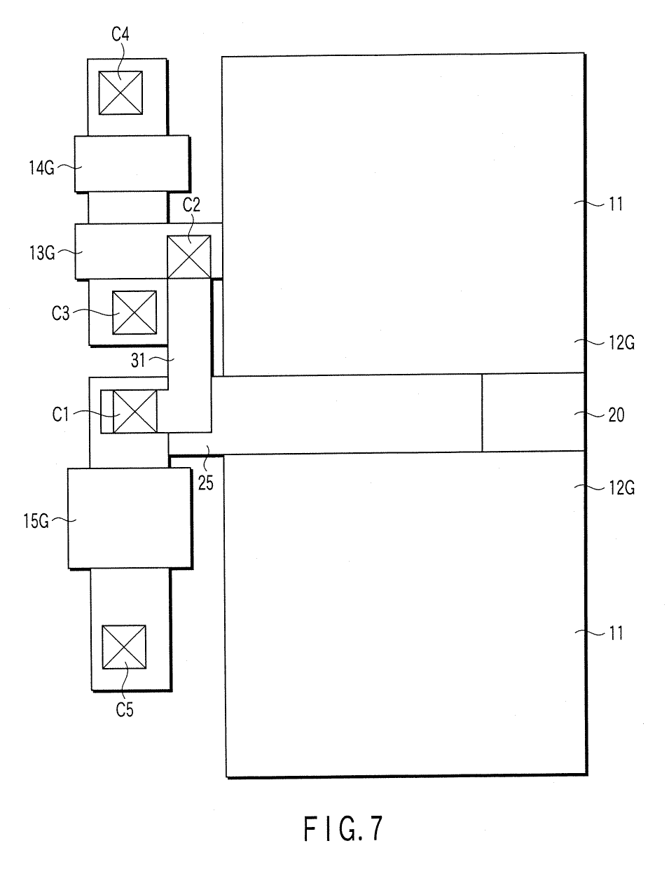

FIG. 7 is a top plan view showing a pattern of a two-pixel one-cell type unit cell in an amplification type CMOS image sensor according to a second embodiment of the present invention. The unit cell according to the second embodiment has the pattern configuration different from the unit cell of the first embodiment described with reference to FIG. 2 in the following point. Specifically, in the unit cell according to the second embodiment, two sets of the photodiodes 11 and read transistors 12 (read gate electrode 12G only is shown in FIG. 7) are formed to have line symmetry with respect to the ion implantation region 25 and the drain side region of the read transistor 12. The two sets of the photodiodes 11 and read transistors 12 share the ion implantation region 25 and the drain side region of the read transistor 12. The amplifying transistor 13 (amplifying gate electrode 13G only is shown in FIG. 7) and the vertical select transistor 14 (address gate electrode 14G only is shown in FIG. 7) are arrayed on one side of one of the two sets of the photodiodes 11 and read transistors 12. The reset transistor (reset gate electrode 13G only is shown in FIG. 7) is arrayed on one side of the other of the two sets of the photodiodes 11 and read transistors 12.

According to the second embodiment, as in the first embodiment, the ion implantation region 25 functioning as the signal charge detecting portion is formed in a part of the semiconductor region on the drain side of the read transistors 12. Therefore, the same effect as described in the first embodiment is obtained.

### Third Embodiment

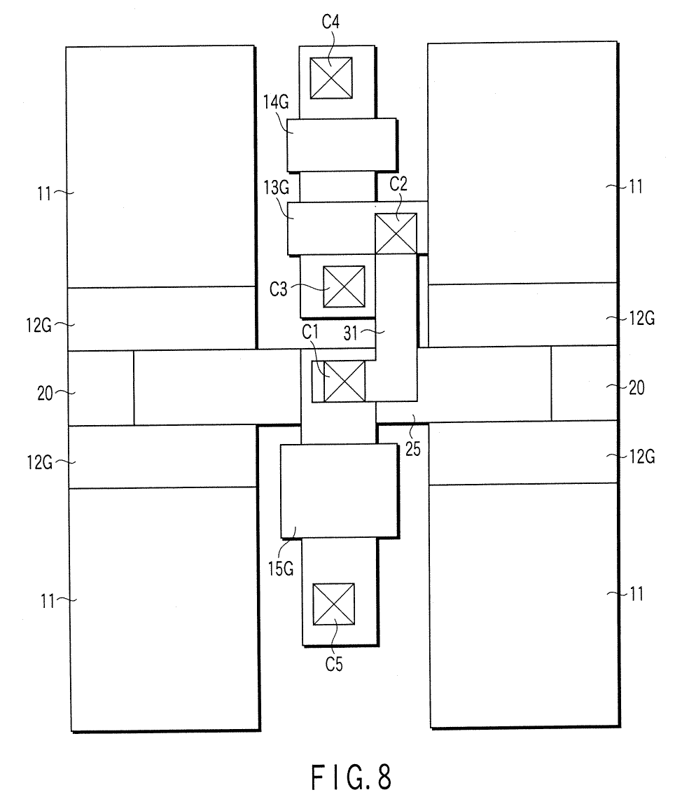

FIG. 8 is a top plan view showing a pattern of a four-pixel one-cell type unit cell in an amplification type CMOS image sensor according to a third embodiment of the present invention. The unit cell according to the third embodiment has the pattern configuration different from the unit cell described with reference to FIG. 7 in the following point. Specifically, further two sets (i.e., second two sets) of the photodiodes 11 and read transistors 12 are provided. The second two sets of the photodiodes 11 and read transistors 12 have the same configuration as said two sets (i.e., first two sets) of the photodiodes 11 and read transistors 12 shown in FIG. 7. The first and second two sets of the photodiodes 11 and read transistors 12 are arrayed to have line symmetry to each other with respect to the amplifying transistor 13, the vertical select transistor 14 and the reset transistor 15. Two read transistors 12 of the first two sets of the photodiodes 11 and read transistors 12 share one drain side region and one ion implantation region 25. Two read transistors 12 of the second two sets of the photodiodes 11 and read transistors 12 share another drain side region and another ion implantation region 25. The source of the reset transistor 15 and the gate electrode interconnection 31 of the amplifying transistor are connected to these ion implantation regions 25.

According to the third embodiment, as in the first embodiment, each of the ion implantation regions 25 functioning as the signal charge detecting portion is formed in a part of the semiconductor region on the drain side of the read transistors 12. Therefore, the same effect as described in the first embodiment is obtained.

According to the foregoing embodiments, the well region is of P type. However, as shown in FIG. 10, the well region may be changed into an N type well region, the P type impurity diffusion regions may be changed into N type impurity diffusion regions, and the N type impurity diffusion region may be changed into P type impurity diffusion regions. Even in such a modified example, the same effect as described in the first embodiment is obtained.

Although the conversion gain of the read transistor may be increased by small-sizing the semiconductor region on the drain side of the read transistor, it is not easy to further enhance the small-sizing in view of the process technology. Even when the semiconductor region on the drain side of the read transistor could be further small-sized to thereby increase the conversion gain of the read transistor, there always exists demand for further increasing the conversion gain of the read transistor to further increase the saturation output of the sensor. In light of this aspect, it is preferable as an actual technique to form a signal charge detecting portion in a part of the semiconductor region on the drain side of the read transistor by ion implantation, as described in the foregoing embodiments, to further increase the conversion gain of the read transistor to further increase the saturation output of the sensor. Furthermore, according to the technique of ion implantation as described above, even when there is required a saturation output larger than the original design value, it is easy to change the area of the signal charge detecting portion so that it is easy to increase the conversion gain of the read transistor to increase the saturation output of the sensor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A solid-state image sensor having an image region including a plurality of unit cells arrayed in a matrix on a semiconductor substrate, in which each of the unit cells comprises:
a photodiode provided in the semiconductor substrate, which converts an input light signal into a signal charge and stores the signal charge;
a MOS type read transistor provided adjacent to the photodiode in a surface layer of the semiconductor substrate, which transfers the signal charge stored in the photodiode to a signal charge detecting portion; and
an amplifying transistor which amplifies the signal charge transferred to the signal charge detecting portion to output a voltage signal,
wherein the signal charge detecting portion comprises an ion implantation region formed in a part of a surface layer of a semiconductor region on a drain side of the MOS type read transistor.

2. The solid-state image sensor according to claim 1, wherein the signal charge detecting portion comprises an N type region formed in a P type semiconductor region.

3. The solid-state image sensor according to claim 1, wherein the signal charge detecting portion comprises a P type impurity ion implantation region formed in an N type semiconductor region.

4. The solid-state image sensor according to claim 1, wherein the ion implantation region includes a portion under a side edge of a gate electrode of the read transistor.

5. The solid-state image sensor according to claim 1, wherein a width of the ion implantation region in a channel direction of the read transistor is smaller than that width of the semiconductor region on the drain side of the reset transistor, which width is a width in a direction perpendicular to the channel direction of the reset transistor.

6. The solid-state image sensor according to claim 1, wherein the unit cell comprises a plurality of sets of the photodiodes and read transistors, and the plurality of sets of the photodiodes and read transistors share the ion implantation region.

7. The solid-state image sensor according to claim 1, wherein
the unit cell further comprises a MOS type vertical select transistor which transfers an output voltage signal of the amplifying transistor to a vertical output line and a MOS type reset transistor which resets the signal charge stored in the signal charge detecting portion,
the unit cell comprises a plurality of sets of the photodiodes and read transistors, and the plurality of sets of the photodiodes and read transistors share the amplifying transistor, the vertical select transistor and the reset transistor.

8. The solid-state image sensor according to claim 1, wherein the unit cell includes two sets of the photodiodes and read transistors, and the two sets of the photodiodes and read transistors share the ion implantation region.

9. The solid-state image sensor according to claim 8, wherein the two sets of the photodiodes and read transistors are arrayed to have line symmetry to each other with respect to the semiconductor region on the drain side of the read transistor and the ion implantation region formed on the part of the semiconductor region.

10. The solid-state image sensor according to claim 8, wherein the unit cell further comprises a MOS type vertical select transistor which transfers an output voltage signal of the amplifying transistor to a vertical output line, and a MOS type reset transistor which resets the signal charge stored in the signal charge detecting portion,
the amplifying transistor, the vertical select transistor and the reset transistor are arrayed on one side of the two sets of the photodiodes and read transistors, and shared by the two sets of the photodiodes and read transistors.

11. The solid-state image sensor according to claim 8 comprises further two sets of the photodiodes and read transistors having the same configuration as said two sets of the photodiodes and read transistors, and said two sets and said further two sets of the photodiodes and read transistors pairs are arrayed to have line symmetry to each other with respect to the amplifying transistor, the vertical transistor and reset transistor.
